(19) United States
(12) Patent Application Publication
(10) Pub. No.: US 2013/0074708 A1
(43) Pub. Date: Mar. 28, 2013

(54) VERTICAL JUICER WITH COMPRESSION STRAINER DEVICE

(71) Applicant: GREENFIELD WORLD TRADE, INC., Weston, FL (US)

(72) Inventors: Neal Asbury, Weston, FL (US); Dong Un Kim, Rochester, MI (US)

(73) Assignee: GREENFIELD WORLD TRADE, INC., Weston, FL (US)

(21) Appl. No.: 13/628,902

(22) Filed: Sep. 27, 2012

Related U.S. Application Data
(60) Provisional application No. 61/539,552, filed on Sep. 27, 2011.

(51) Int. Cl. A23N 1/02

(52) U.S. Cl. 99/513; 99/495

(57) ABSTRACT

A vertical juicer adapted to extract juice from a food including a bowl and a motor connected to the bowl. The vertical juicer also has a filter disposed in the bowl, an auger disposed in the filter, and a brush disposed between the bowl and the filter. A gear system includes a first gear disposed on the auger and a second gear disposed on the brush. Actuation of the auger by the motor causes the auger and first gear to rotate, and rotation of the first gear causes the second gear to rotate. Rotation of the second gear causes the brush to rotate around the filter and remove a food residue from the filter.

### CROSS-REFERENCE TO RELATED APPLICATION

This application claims priority to U.S. Provisional Application Serial. No. 61/539,552, filed Sep. 27, 2011, the entire disclosure of which is hereby incorporated herein by reference.

### FIELD OF THE INVENTION

The present disclosure relates to an extractor, and more particularly to a vertical juice extractor used for optimizing an amount of juice extracted from fruits and vegetables.

### BACKGROUND OF THE INVENTION

Various juicers are known in the prior art. Specifically, there are three main types of juicers: masticating, centrifugal, and triturating. Masticating juicers, or single gear juicers, grind the fibers of fruits and vegetables to extract more vitamins, enzymes, and minerals. Accordingly, the masticating juicers operate at slower speeds than other juicers.

Known masticating juicers are inefficient. For example, many masticating juicers include only one strainer, making it difficult to extract all of the juice out from various foods. Additionally, masticating juicers may not produce an optimal juice output due to residue from the foods blocking openings of the strainer, through which the juice is filtered. Furthermore, heat produced by the friction between various parts of the juicers may negatively affect the nutritional value of the juice output. Accordingly, the juice output, and likewise the nutrient yield, of conventional masticating juicers is lower than desired.

It is desirable to have a vertical juice extractor that maximizes juice output and optimizes a nutritional content of the extracted juice.

### SUMMARY OF THE INVENTION

Consonant with the instant disclosure, a vertical juice extractor that maximizes juice output and optimizes a nutritional content of the extracted juice, has surprisingly been discovered.

In one embodiment of the disclosure, a vertical juice extractor for extracting juice from a food includes a bowl, a filter apparatus having a filter frame and at least one filter screen disposed in the bowl, and an auger disposed in the filter apparatus. The filter apparatus has a plurality of ribs vertically disposed on an inner surface of the filter apparatus. The auger includes a blade originating at a first end of the auger disposed spirally around an outer surface of the auger. The auger also has a plurality of ribs disposed on a second end of the auger.

In another embodiment of the disclosure, a vertical juice extractor for extracting juice from a food includes a bowl, a filter apparatus disposed in the bowl, an auger disposed in the filter, and a brush apparatus disposed between the bowl and the filter. The brush apparatus includes a brush frame and at least one brush. The juice extractor also includes a gear system including a first gear disposed on the auger and a second gear disposed on the brush apparatus. Actuation of the auger by a motor causes the auger and the first gear to rotate. Rotation of the first gear actuates and rotates the second gear, and rotation of the second gear actuates and rotates the brush apparatus.

In yet another embodiment of the disclosure, a vertical juice extractor adapted to extract juice from a food includes a bowl and a filter apparatus including a filter frame and at least one filter screen disposed in the bowl. The filter apparatus includes a plurality of ribs vertically disposed on an inner surface of the filter apparatus. The juice extractor also includes an auger disposed in the filter apparatus. The auger includes a blade originating at a first end of the auger disposed spirally around an outer surface of the auger and a plurality of ribs disposed on a second end of the auger. The juice extractor also has a brush apparatus disposed between the bowl and the filter apparatus including a brush frame and at least one brush. A gear system is also included in the juice extractor. The gear system includes a first gear disposed on the second end of the auger, a second gear disposed on a first end of the brush apparatus adjacent a bottom portion of the bowl, and a third gear disposed on the bottom portion if the bowl. A motor actuates the auger and causes the auger and the first gear to rotate. Rotation of the first gear actuates and rotates the third gear. Rotation of the third gear actuates and rotates the second gear, and rotation of the second gear causes the at least one brush to contact and rotate around the at least one filter screen and remove a food residue from the at least one filter screen.

### DRAWINGS

The above, as well as other advantages of the present disclosure, will become readily apparent to those skilled in the art from the following detailed description, particularly when considered in the light of the drawings described hereafter.

FIG. 1 shows a side perspective view of a vertical juice extractor according to one embodiment of the present disclosure;

FIG. 2 shows a side perspective view of the bowl of the vertical juice extractor depicted in FIG. 1;

FIG. 3 shows a cross-sectional side elevational view of a subassembly of the vertical juice extractor depicted in FIG. 1, including bowl, a filter, an auger, and a brush;

FIG. 4 shows a bottom perspective view of the filter, the auger, and the brush of the subassembly depicted in FIG. 2;

FIG. 5 shows an exploded top perspective view of the subassembly depicted in FIG. 2, including the auger, the filter, the brush, and the bowl; and

FIG. 6 shows a bottom perspective view of the bowl of the subassembly depicted in FIGS. 1, 2, and 4.

### DETAILED DESCRIPTION OF THE INVENTION

The following detailed description and appended drawings describe and illustrate various exemplary embodiments of the invention. The description and drawings serve to enable one skilled in the art to make and use the invention, and are not intended to limit the present disclosure, application, or uses. It should also be understood that throughout the drawings, corresponding reference numerals indicate like or corresponding parts and features.

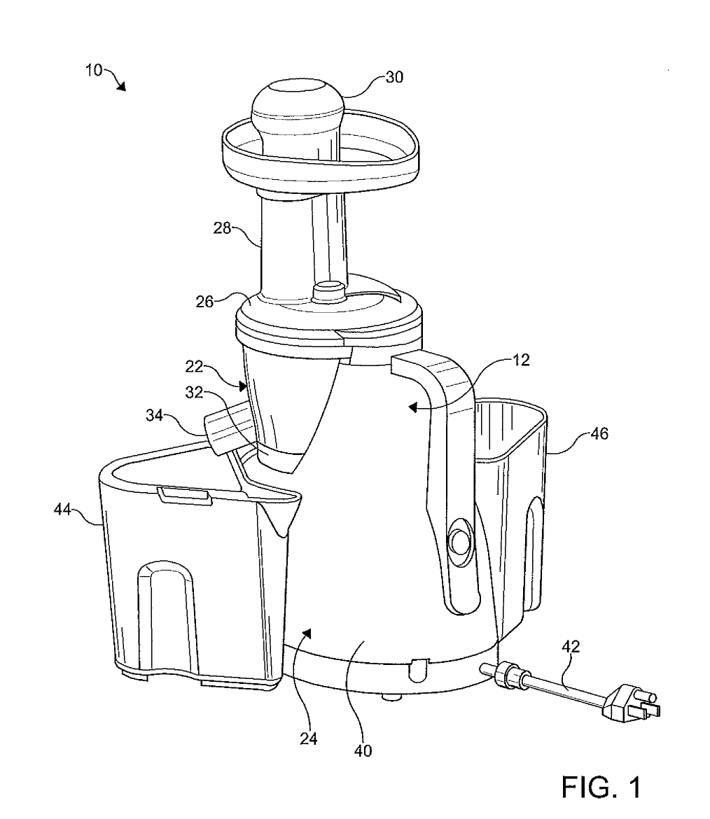

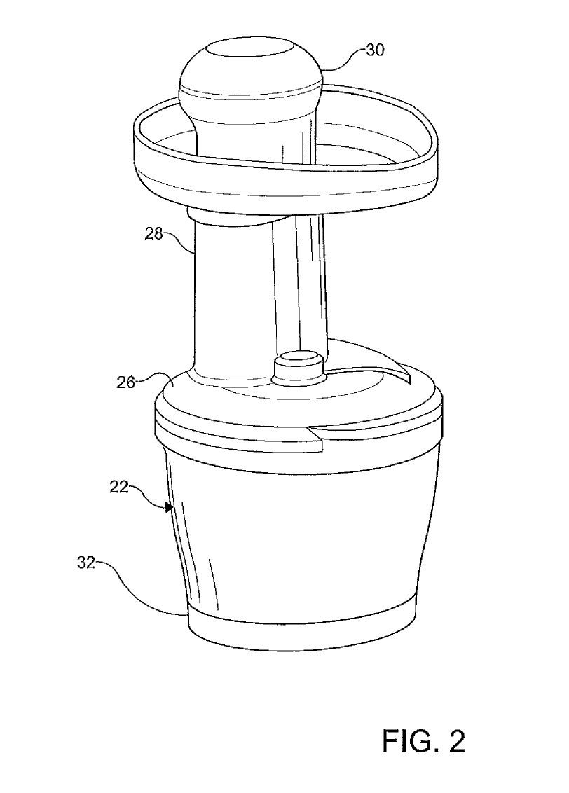

FIGS. 1-6 illustrate a vertical juice extractor 10. The vertical juice extractor 10 includes a main body 12, a filter apparatus 14, an auger 16, a brush apparatus 18, and a gear system 20. The vertical juice extractor 10 may be used to extract a juice from foods such as fruits and vegetables, for example.

As shown in FIG. 1, the main body 12 includes a bowl 22 and a base 24. The bowl 22 is formed from a polycarbonate material but may be formed from other suitable material such as metal or plastic, for example. The bowl 22 may be any size and shape capable of housing the filter apparatus 14, the auger 16, and the brush apparatus 18.

In particular embodiments, the bowl 22 may include a lid 26 that is removably connected to the bowl 22 at a first end of the bowl. The lid 26 may be formed from the polycarbonate material or a different material, as desired. A feed channel 28 through which food is passed may be permanently or removably connected to the bowl 22 or the lid 26. An insert 30 may be used to force the food through the feed channel 28, if necessary.

A bottom portion 32 is disposed at a second end of the bowl 22. The bottom portion 32 has a recess that extends inwardly toward a center of the bowl 22. A juice outlet 34 extends radially outward from a side wall adjacent the bottom portion 32 of the bowl 22, and a residue outlet 36 extends radially outward from the bottom portion 32 of the bowl 22. The juice outlet 34 and the residue outlet 36 may be permanently or removably connected to the bowl 22, and may be made from the polycarbonate material or a different suitable material, as desired.

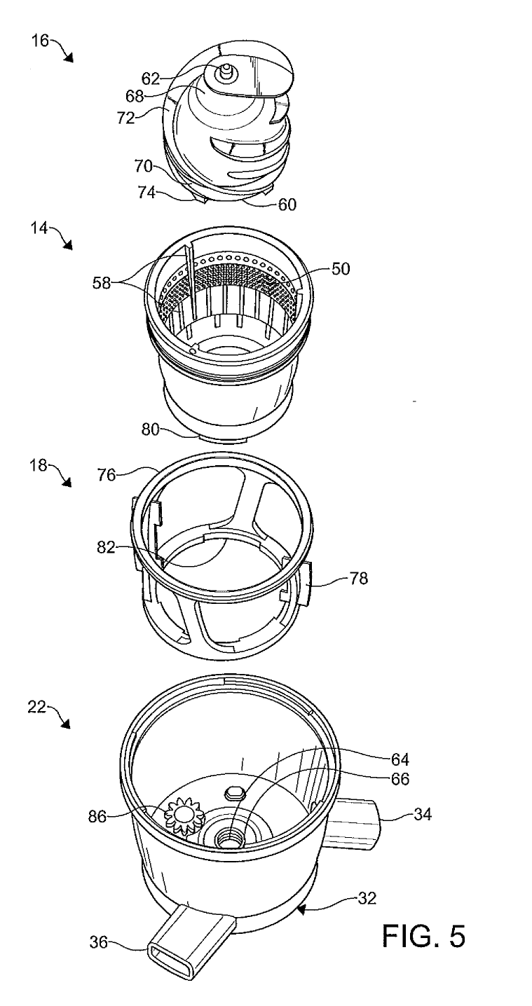

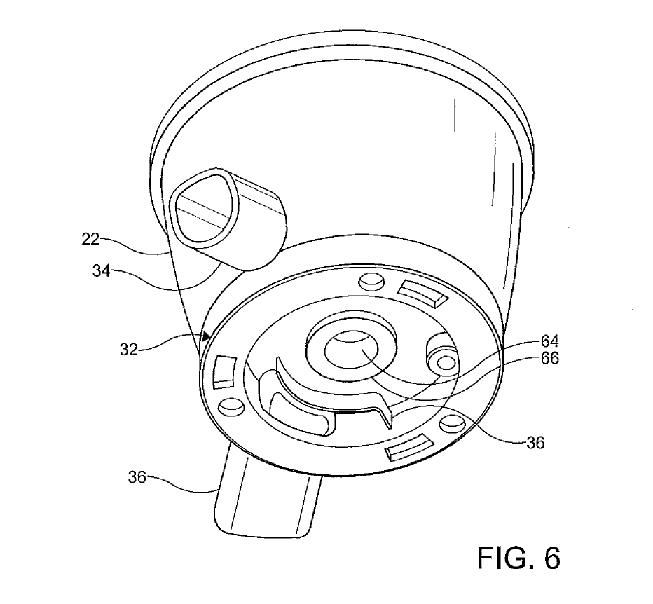

As shown in FIG. 5, a residue outlet seal 38 is disposed at a first end of the residue outlet 36. The first end of the residue outlet 36 is adjacent the bottom portion 32 of the bowl 22. The residue outlet seal 38 may be produced from any hard material capable of withstanding pressure from a residue that accumulates in the bottom portion 32 of the bowl 22 while the vertical juice extractor 10 is in use such as silicone, for example. Other suitable materials may also be used for the residue outlet seal 38 within the scope of the present disclosure.

The base 24 may include a shell 40 and a motor 42 and is removably connected to the bottom portion 32 of the bowl 22. The shell 40 may be produced from the polycarbonate material or a different material and may be any size and shape capable of housing the motor 42 and providing stability to the vertical juice extractor 10. The motor 42 may be an electrical motor such as an induction motor, for example, powered by battery, or any other motor capable of producing the required wattage, current, and the like, to rotate the auger 16. In other embodiments, the motor 42 is in electrical communication with an external power source such as an electrical outlet via an electrical cord with a plug. The motor 42 may include a control device not shown) for activating the auger 16.

The main body 12 may further include a juice container 44 and a residue container 46. The juice container 44 is removably connected to the main body 12 adjacent to, or under, the juice outlet 34. Likewise, the residue container 46 is removably connected to the main body 12 adjacent to, or under, the residue outlet 36. The juice container 44 and the residue container 46 may be formed from the polycarbonate material or a different suitable material, as desired.

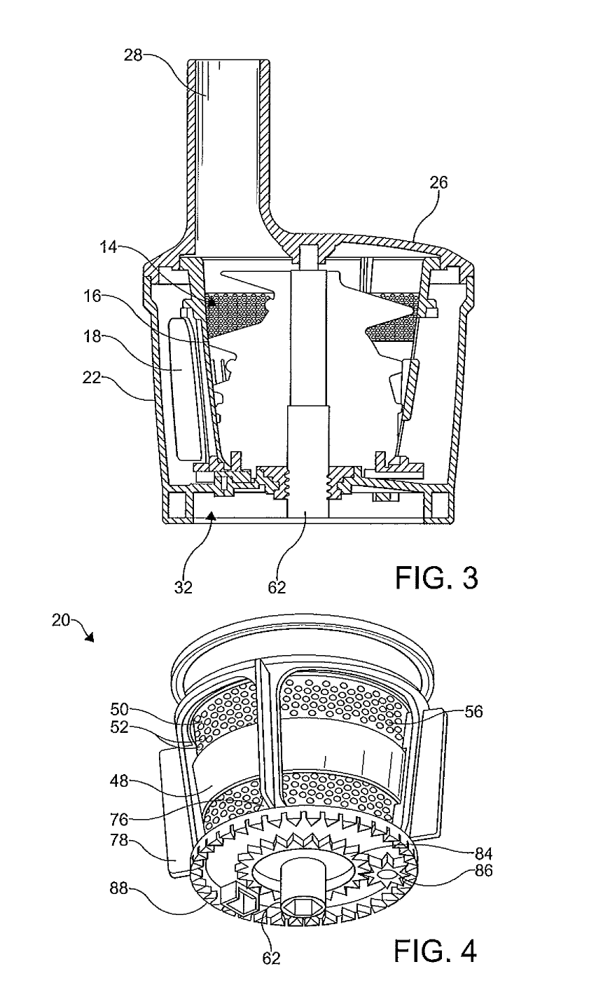

The filter apparatus 14 is disposed in the bowl 22 when the vertical juice extractor 10 is in use (see FIG. 3). As shown in FIG. 4, the filter apparatus 14 includes a filter frame 48 and at least one filter screen 50 formed in the filter frame 48. The filter frame 48 is produced from a polyether imide or any other suitable material that is heat resistant with a high tensile strength. The at least one filter screen 50 is made from stainless steel or any other suitable material that is easy to clean and capable of withstanding pressure from the auger 16 when the vertical juice extractor 10 is in use.

The filter screen 50 includes a plurality of filter openings 52. Each filter opening 52 has a first diameter 54 adjacent an area inside the filter apparatus 14 and a second diameter 56 adjacent an area outside of the filter apparatus 14. The first diameter 54 of each filter opening is smaller than the second diameter 56. The smaller first diameter 54 militates against food filtering through the filter screen 50 and the larger second diameter 56 optimizes the amount of juice filtered through the filter screen 50.

The filter frame 48 and the at least one filter screen 50 have a plurality of filter ribs 58 disposed on an inner surface of the filter apparatus. Each filter rib 58 extends vertically on the inner surface of the filter apparatus 14 but may be oriented in any appropriate position. The feed channel 28 and the filter apparatus 14 are in fluid communication with one another.

The auger 16 is disposed in the filter apparatus 14 and is produced from a heat resistant, high tensile strength, material such polyether imide, for example. As shown in FIG. 4, the auger 16 has a bottom surface 60 having a concave shape extending inward toward a center of the auger 16. A transmission shaft 62 extends through the center of the auger 16 and is powered by the motor 42. A first end of the transmission shaft 62 extends through an aperture 64 located at a center of the bottom portion 32 of the bowl 22, and connects to the motor 42.

As further shown in FIG. 4, a center sealing ring 66 is disposed around the aperture 64 where the transmission shaft 62 extends through the bottom surface 32 of the bowl 22. The transmission shaft 62 rotates the auger 16 at a speed of 80 rpm with a force of 38.65 Nm. A pin (not shown) may be used to orient the transmission shaft 62 and the auger 16 in a specific axial and radial position in the center of the bowl 22.

The auger 16 has a top portion 68 at a first end of the auger 16, disposed adjacent the feed channel 28. The auger 16 also has a bottom portion 70 at a second end of the auger 16, disposed adjacent the bottom portion 32 of the bowl 22. A diameter of the auger 16 increases from the top portion 68 of the auger 16 to the bottom portion 70 of the auger 16. Accordingly, a space between the auger 16 and the filter apparatus 14 becomes smaller as the diameter of the auger 16 increases. As a result, there is an increased pressure on the food that results in further extraction of the food.

At least one blade 72 extends outwardly from an outer surface of the auger 16. The at least one blade 72 is arranged in a spiraling manner from the top portion 68 of the auger 16 to the bottom portion 70 of the auger 16. As the diameter of the auger 16 increases, a width of the blade 72 decreases. A wider portion of the at least one blade 72 at the top portion 68 of the auger 16 initially breaks down the food as it enters the filter apparatus 14. The width of the blade 72 decreases so that the increased pressure between the bottom portion 70 of the auger 16 and the filter apparatus 14 can further extract juice from the food.

A plurality of auger ribs 74 are disposed on an outer surface of the auger 16 adjacent the second end of the auger 16. Each auger rib 74 extends laterally outwardly from the outer surface of the bottom portion 70 of the auger 16. The auger ribs 74 further extract juice from the food and also prevent the food from exiting the filter apparatus so that the food has a maximized squeezing time.

As shown in FIG. 3, the brush apparatus 18 is disposed between the bowl 22 and the filter apparatus 14. The brush apparatus 18 includes a brush frame 76 and at least one brush 78. The brush frame 76 is formed from a polyacetal material or any other suitable material capable of minimizing friction between the brush apparatus 18 and the filter apparatus 14. The at least one brush 78 is produced from a flexible material such as silicone, for example. Other suitable materials for the at least one brush 78 may also be used within the scope of the disclosure.

The at least one brush 78 may be integral with the brush frame 76 or may be removably or permanently connected to the brush frame 76. The brush apparatus 18 and the filter apparatus 14 are rotatingly connected to each other in such a manner as to allow the brush apparatus 18 to rotate around the filter apparatus 14. For example, the brush apparatus 18 may have a female thread portion 80 rotatingly coupled to a male thread 82 of the filter apparatus 14. When the filter apparatus 14 is disposed in the brush apparatus 18, the at least one brush 78 is disposed adjacent to and makes contact with the at least one filter screen 50.

As shown in FIG. 4, the gear system 20 includes a first gear 84, a second gear 86, and a third gear 88. However, the gear system 20 may include any number of gears, as desired. The first gear 84 cooperates with the second gear 86, and the second gear 86 cooperates with the third gear 88. The first gear 84 is disposed on the bottom portion 70 at the second end of the auger 16. The first gear 84 is actuated by rotation of the auger 16 by the transmission shaft 62 when the vertical juice extractor 10 is in use. The second gear 86 is disposed on an inside surface of the bottom portion 32 of the bowl 22 and is interconnected with and actuated by rotation of the first gear 84. The third gear 88 is disposed around a peripheral edge of a bottom surface of the brush apparatus 18 and is interconnected with and actuated by rotation of the second gear 86.

The location of the first gear 84, the second gear 86, and the third gear 88 may vary according to different embodiments. The gear system 20 may be produced from metal or any other suitable material capable of withstanding pressure from continued rotation of the auger 16. In particular embodiments, the gear system 20 may be in a ring distribution or other appropriate distribution.

In operation, food is inserted into the feed channel 28 and the motor 42 is turned on. The insert 30 may be used to force the food through the feed channel 28. The smaller diameter of the top portion 68 of the auger 16 permits the food to drop into the filter apparatus 14. The motor 42 rotates the transmission shaft 62 of the auger 16, causing the auger 16 to rotate. The juice is initially extracted from the food by the wider portion of the blade 72 disposed at the top portion 68 of the auger 16. As the food passes further into the filter apparatus 14 the width of the blade 72 decreases and the diameter of the auger 16 increases. Accordingly, the juice is extracted more by the increased pressure between the auger 16 and the filter apparatus 14 and less by the blade 72 as the food passes through the filter apparatus 14. Additionally, the filter ribs 58 aid in extracting the juice from the food. The juice exits the filter apparatus 14 through the filter openings 52 in the at least one filter screen 50.

It should be appreciated that the first diameter 54 of the filter openings 52 militate against a food residue from filtering through the filter apparatus 14 with the juice, while the second diameter 56 of the filter openings 52 allow more juice to be extracted. The juice then flows down to the bottom portion 32 of the bowl 22 and exits the vertical juice extractor through the juice outlet 34. The concave shape of the bottom portion 32 of the bowl 22 improves a flowing of juice into the juice outlet 34 and minimizes an amount of residue left over in the bottom portion 32 of bowl 22. The residue that is not filtered through the filter openings 52 remains inside the filter apparatus 14 and is pushed down to the bottom portion 32 of the bowl 22. The residue outlet seal 38 militates against the residue exiting the bowl 22 until an adequate pressure is built up in the filter apparatus 14. Accordingly, the residue outlet seal 38 allows for more juice to be extracted from the residue by militating against the residue exiting the filter apparatus 14.

The rotation of the transmission shaft 62 causes the auger 16 and the first gear 84 to rotate. Rotation of the first gear 84 actuates the second gear 86 which in turn actuates the third gear 88. The third gear 88 causes the brush apparatus 18 to rotate around the filter apparatus 14. The rotation of the brush apparatus 18 causes the at least one brush 78 to make contact with the at least one filter screen 50 and effectively remove residue from the at least one filter screen 50 while the vertical juice extractor 10 is in use. Accordingly, the at least one filter screen 50 remains free from residue allowing more juice to exit through the filter openings 52.

The gear system 20 in combination with the transmission shaft 62 increases the power of the rotating auger 16 and decreases the speed at which the auger 16 rotates. Ideally the gear system 20 reduces the speed at which the transmission shaft 62 rotates the auger 16 by a reduction ratio of about 22.6:1. Accordingly, the auger 16 rotates at a speed of about 80 rpm with a force of about 38.65 Nm. However, the speed at which the auger 16 rotates may vary. The auger ribs 74 disposed on the auger 16 may also slow down the speed at which the auger 16 rotates.

The slower speed at which the auger 16 rotates allows for the maximized squeezing time and a higher juice output as a result. The residue outlet seal 38 also contributes to the maximized squeezing time by militating against the residue exiting the filter apparatus 14. The increased power of the auger 16 allows for an improved extraction of the juice from the food. Additionally, the filter openings 52 militate against residue exiting the filter apparatus 14 with the juice output which improves a quality of the juice output, and the at least one brush 78 prevents a residue build-up in the filter openings 52 allowing for more juice to pass through the filter openings 52. Furthermore, the slower speed at which the auger 16 rotates reduces a build-up of heat caused by friction between the auger 16, the filter apparatus 14, and the brush apparatus 18, allowing for an optimal nutritional content of the juice output.

While certain representative embodiments and details have been shown for purposes of illustrating the invention, it will be apparent to those skilled in the art that various changes may be made without departing from the scope of the disclosure, which is further described in the following appended claims.

What is claimed is:

1. A vertical juice extractor for extracting juice from a food, comprising:
a bowl;
filter apparatus including a filter frame and at least one filter screen disposed in the bowl; and
an auger disposed in the filter apparatus,
wherein the filter apparatus has a plurality of ribs vertically disposed on an inner surface of the filter apparatus, and
wherein the auger includes a blade originating at a first end of the auger disposed spirally around an outer surface of the auger and a plurality of ribs disposed on a second end of the auger.

2. The vertical juice extractor of claim 1, wherein a bottom surface of the auger has a concave shape extending inward toward a center of the auger.

3. The vertical juice extractor of claim 1, wherein a bottom surface of the bowl has a concave shape extending inward toward a center of the bowl.

4. The vertical juice extractor of claim 1, wherein a residue outlet extends radially outward from a bottom portion of the bowl.

5. The vertical juice extractor of claim 1, wherein the filter screen has a plurality of filter openings and each filter opening has a first diameter adjacent an inside of the filter apparatus and a second diameter adjacent an outside of the filter apparatus and wherein the first diameter is smaller than the second diameter.

6. The vertical juice extractor of claim 1, wherein a diameter of the auger increases from the first end of the auger to the second end of the auger, the second end of the auger being adjacent a bottom portion of the bowl.

7. The vertical juice extractor of claim 6, wherein the blade has a width that decreases from the first end of the auger to the second end of the auger.

8. The vertical juice extractor of claim 1, wherein each rib of the plurality of ribs extends laterally outwardly from an outer surface of a bottom portion of the auger.

9. The vertical extractor of claim 1, wherein a gear system decreases a speed at which the auger rotates to about 80 revolutions per minute.

10. A vertical juice extractor for extracting juice from a food, comprising:
a bowl;
a filter apparatus disposed in the bowl;
an auger disposed in the filter;
a brush apparatus disposed between the bowl and the filter including a brush frame and at least one brush; and
a gear system including a first gear disposed on the auger and a second gear disposed on the brush apparatus,
wherein actuation of the auger by a motor causes the auger and the first gear to rotate,
wherein rotation of the first gear actuates and rotates the second gear, and wherein rotation of the second gear actuates and rotates the brush apparatus.

11. The vertical juice extractor of claim 10, wherein the first gear is disposed on a first end of the auger adjacent a bottom portion of the bowl, and the second gear is disposed on a first end of the at least one brush apparatus adjacent the bottom portion of the bowl.

12. The vertical juice extractor of claim 10, wherein the first gear and the second gear of the gear system are in a ring distribution.

13. The vertical juice extractor of claim 10, wherein a third gear disposed on the bottom portion of the bowl is disposed between the first gear and the second gear.

14. The vertical juice extractor of claim 13, wherein the motor actuates the auger and causes the auger and the first gear to rotate, rotation of the first gear actuates and rotates the third gear, rotation of the third gear actuates and rotates the second gear, and rotation of the second gear causes the at least one brush to contact and rotate around the at least one filter screen and remove a food residue from the at least one filter screen.

15. The vertical juice extractor of claim 10, wherein a speed at which the auger rotates is about 80 revolutions per minute.

16. A vertical juice extractor for extracting juice from a food, comprising:
a bowl;
filter apparatus including a filter frame and at least one filter screen disposed in the bowl, the filter apparatus including a plurality of ribs vertically disposed on an inner surface of the filter apparatus;
an auger disposed in the filter apparatus, the auger includes a blade originating at a first end of the auger disposed spirally around an outer surface of the auger and a plurality of ribs disposed on a second end of the auger;
a brush apparatus disposed between the bowl and the filter apparatus including a brush frame and at least one brush; and
a gear system including a first gear disposed on the second end of the auger, a second gear disposed on a first end of the brush apparatus adjacent a bottom portion of the bowl, and a third gear disposed on the bottom portion if the bowl,
wherein a motor actuates the auger and causes the auger and the first gear to rotate, rotation of the first gear actuates and rotates the third gear, rotation of the third gear actuates and rotates the second gear, and rotation of the second gear causes the at least one brush to contact and rotate around the at least one filter screen and remove a food residue from the at least one filter screen.

17. The vertical juice extractor of claim 16, wherein the at least one filter screen includes a plurality of filter openings and each filter opening of the plurality of filter openings has a first diameter adjacent an inside of the filter apparatus and a second diameter adjacent an outside of the filter apparatus and wherein the first diameter is smaller than the second diameter.

18. The vertical juice extractor of claim 16, wherein a diameter of the auger increases from the first end of the auger to the second end of the auger, and wherein a blade spirally extends outwardly from an outer surface of the auger and has a width that decreases from the first end of the auger to the second end of the auger.

19. The vertical juice extractor of claim 16, wherein a residue outlet extends outwardly from the bottom portion of the bowl and a seal is disposed over an opening of the residue outlet.

20. vertical juice extractor of claim 16, wherein the gear system reduces a speed at which a transmission shaft rotates the auger by a reduction ratio of about 22.6 to 1.
